(19) United States
(12) Patent Application Publication
(10) Pub. No.: US 2012/0163245 A1
(43) Pub. Date: Jun. 28, 2012

(54) MODULE FOR MOBILE COMMUNICATION TERMINAL AND MOBILE COMMUNICATION TERMINAL

(75) Inventors: Masazumi Tone, Ebina (JP); Akio Yamamoto, Hiratsuka (JP); Takashi Shiba, Yokosuka (JP); Osamu Hikino, Yokohama (JP)

(73) Assignee: Hitachi Media Electronics Co., Ltd.

(21) Appl. No.: 13/296,286

(22) Filed: Nov. 15, 2011

(30) Foreign Application Priority Data
Dec. 24, 2010 (JP) 2010-287756

(51) Int. Cl. H04L 5/14

(52) U.S. Cl. 370/277

(57) ABSTRACT

A tunable filter has an out-of-band signal suppression amount of 30 dB that is smaller than 50 dB, the suppression amount of a typical duplexer. Thus, a canceller having a suppression amount of about 20 dB is necessary (particularly, a method is provided to obtain a suppression amount over a wide band without being adversely affected by the group delay characteristics and frequency characteristics of an amplifier included in a canceller). Delay devices corresponding to the group delay of the amplifier are disposed on the signal path of the tunable filter. The canceller includes a matching circuit that adjusts an amplitude, a phase, and a delay, a wide-band amplifier that has small amplitude fluctuations and small phase fluctuations over the frequency bands of a transmission signal and a reception signal, a variable-impedance transmission coupler, and a variable-impedance reception coupler.

### INCORPORATION BY REFERENCE

This application relates to and claims priority from Japanese Patent Application No. 2010-287756 filed on Dec. 24, 2010, the entire disclosure of which is incorporated herein by reference.

### BACKGROUND OF THE INVENTION

(1) Field of the Invention

The present invention relates to a module for a mobile communication terminal and the mobile communication terminal. The present invention particularly relates to a module for a mobile communication terminal and the mobile communication terminal which are provided for wireless communication systems including Wideband Code Division Multiple Access (WCDMA) or Long Term Evolution(LTE).

(2) Description of the Relate Art

An LTE system has been studied in addition to a WCDMA system having been practically used for cellular phones. Since transmission and reception are simultaneously performed in the WCDMA and LTE systems, different frequency bands are used for transmission and reception. In these systems, duplexers for separating transmission and reception bands are used.

“Adaptive Duplexer Implemented Using Single-Path and Multipath Feedforward Techniques With BST Phase Shifters; IEEE TRANSACTIONS ON MICROWAVE THEORY AND TECHNIQUES, VOL. 53, NO. 1, p. 106-114, JANUARY 2005” (hereinafter, will be referred to as non-patent document 1) describes a method of cancelling thermal noise in a reception band to compensate for a shortage of out-of-band suppression of a duplexer. A transmission signal is removed using a notch filter. Thermal noise in a reception band from a transmission circuit is adjusted in amplitude and phase, is mixed with transmission and reception signals between the duplexer and an antenna terminal, and then is removed. Thus, the thermal noise in the reception band is cancelled while hardly affecting the transmission signal.

The WCDMA and LTE systems use multiple frequency bands and multiple channels in the same band. In order to obtain excellent high frequency characteristics, a duplexer is provided for each frequency band in a front-end module for a cellular phone. Furthermore, in the LTE system, a technique of Multiple Input Multiple Output (MIMO) is used to achieve higher speeds, so that receiver circuits need to be provided as many as antennas. Hence, it is supposed that receiver circuits will be increased in size in response to higher speeds in the future, a technique of switching duplexers in a tunable manner as described in Japanese Patent Application No. 2009-277142 (Laid-Open No. 2011-120120; described as “patent document 1” bellow) is required.

The patent document 1 describes a tunable filtering technique for switching duplexers in a tunable manner and a cancelling technique. The cancelling technique compensates for a shortage of the out-of-band signal suppression amount of a tunable filter whose variable characteristics allow selective passage of signals in plural frequency bands. A canceller cancels the leakage components of a transmission signal and the leakage components of thermal noise in a reception band. The leakage components of the transmission signal are contained in a reception signal outputted from the tunable filter.

### SUMMARY OF THE INVENTION

In the patent document 1, the out-of-band signal suppression amount of the tunable filter is about 30 dB, which is smaller than an isolation of about 50 dB between transmission and reception of a typical duplexer. Thus, the target of the canceller is about 20 dB.

The present invention has been made in view of this problem and provides a technique for obtaining a required cancelling amount over a wide band.

In order to solve the problem, the present invention is a module for a mobile communication terminal in which a transmission RF signal and a reception RF signal have different frequency bands, the module including: a duplexer filter including: a Tx filter that receives the transmission RF signal from an external transmission RF circuit, allows passage of a signal in the frequency band of the transmission RF signal, and supplies the signal to an external antenna; and an Rx filter that receives the reception RF signal from the antenna, allows passage of a signal in the frequency band of the reception RF signal, and supplies the signal to an external reception RF circuit;

a canceller unit that splits a part of the transmission RF signal from the front stage of the Tx filter included in the duplexer filter, performs predetermined signal processing on the signal, couples the signal with the reception RF signal in the rear stage of the Rx filter included in the duplexer filter, and cancels the leakage components of the transmission RF signal in the reception RF signal and the leakage components of thermal noise, to the reception RF signal, in the frequency band of the reception RF signal in the transmission RF signal; and

a signal delay unit that compensates for a time difference between the signal passing through the duplexer filter and the signal passing through the canceller unit.

The present invention is a mobile communication terminal including a communication antenna that transmits a transmission RF signal containing an information signal and receives a reception RF signal, the transmission RF signal and the reception RF signal having different frequency bands,

the mobile communication terminal further including:

a modulator/demodulator unit that generates the transmission RF signal with the information signal serving as a modulation signal in a format conforming to wireless communication standards, demodulates the reception RF signal received by the antenna, and outputs the information signal; and

a mobile terminal module that supplies, to the antenna, the transmission RF signal supplied from the modulator/demodulator unit, and supplies, to the modulator/demodulator unit, the reception RF signal supplied from the antenna,

the mobile terminal module including:

a duplexer filter including a Tx filter that allows passage of a signal in the frequency band of the transmission RF signal and supplies the signal to the antenna, and an Rx filter that allows passage of a signal in the frequency band of the reception RF signal and supplies the signal to the modulator/demodulator unit;

a canceller unit that splits a part of the transmission RF signal from the front stage of the Tx filter included in the duplexer filter, performs predetermined signal processing on the signal, couples the signal with the reception RF signal in the rear stage of the Rx filter included in the duplexer filter, and cancels the leakage components of the transmission RF signal in the reception RF signal and the leakage components of thermal noise, to the reception RF signal, in the frequency band of the RF signal in the transmission RF signal; and

a signal delay unit that compensates for a time difference between the signal passing through the duplexer filter and the signal passing through the canceller unit.

According to the present invention, a required cancelling amount can be obtained over a wide band. Thus, a tunable duplexer can obtain isolation performance similar to that of a typical duplexer and the basic performance of a module for a mobile communication terminal and the mobile communication terminal can be improved.

### BRIEF DESCRIPTION OF THE DRAWINGS

These and other features, objects and advantages of the present invention will become more apparent from the following description when taken in conjunction with the accompanying drawings wherein:

FIG. 1 is a block diagram illustrating a structural example of a module for a mobile communication terminal according to a first embodiment;

FIG. 2 is a circuit diagram illustrating a wide-band amplifier and matching circuits according to the first embodiment;

FIG. 3 is a circuit diagram illustrating a transmission coupler and a reception coupler according to the first embodiment;

FIG. 4 illustrates a cancelling effect of the first embodiment;

FIG. 5 is a block diagram illustrating a structural example of the mobile communication terminal according to the first embodiment;

FIG. 6 is a block diagram illustrating a structural example of a module for a mobile communication terminal according to a second embodiment; and

FIG. 7 is a block diagram illustrating a structural example of a module for a mobile communication terminal according to a third embodiment.

### DETAILED DESCRIPTION OF THE EMBODIMENTS

Embodiments of the present invention will be described below.

### First Embodiment

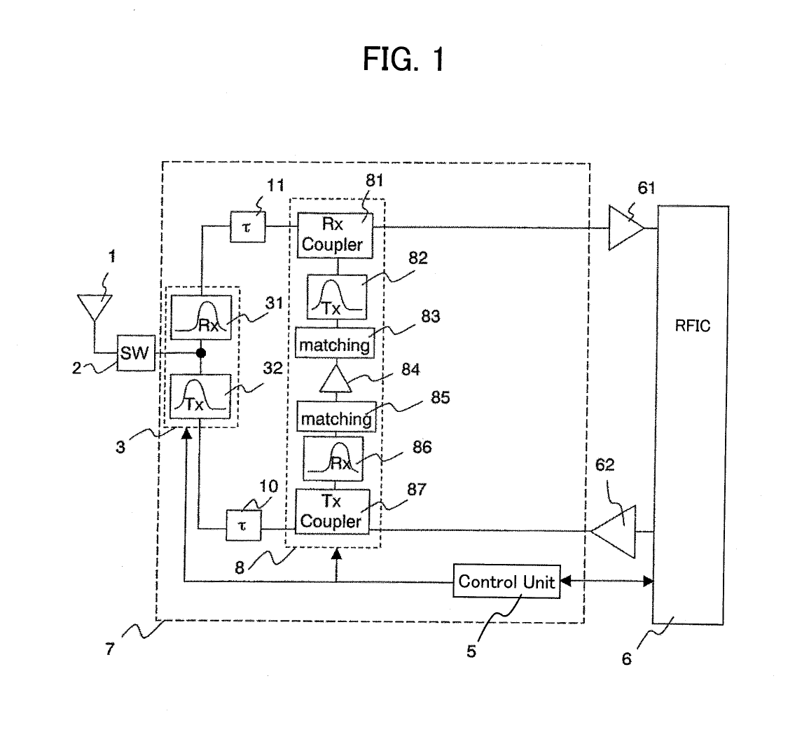

FIG. 1 is a block diagram illustrating a structural example of a module for a mobile communication terminal according to a first embodiment. The configuration of the present embodiment is aimed at modules for mobile communication terminals of, for example, WCDMA and LTE. The configuration is not limited as long as transmission and reception are simultaneously performed in different frequency bands.

The flows of a transmission signal and a reception signal will be first discussed below. A tunable filter 3 serving as a duplexer filter includes a Tx filter 32, an Rx filter 31, and three terminals. The tunable filter 3 is connected to an antenna switch (SW) 2, a transmission system including a power amplifier (PA) 62, and a reception system including a low noise amplifier (LNA) 61. The transmission signal (transmission RF signal) outputted from a transmission RF circuit included in an RFIC 6 is inputted to the PA 62 and is amplified to a predetermined signal level. After that, the transmission signal passes through a transmission coupler 87 in a canceller 8 and a delay device 10 and is inputted to the tunable filter 3. The Tx filter 32 in the tunable filter 3 suppresses signals other than the transmission signal and allows the passage of the transmission signal with a low loss. The transmission signal outputted from the tunable filter 3 passes through an antenna SW 2 and is outputted to the outside from an antenna 1.

The reception signal (reception RF signal) is inputted from the antenna 1 to the tunable filter 3 through the antenna SW 2. The Rx filter 31 in the tunable filter 3 suppresses leakage of the transmission signal and allows the passage of the reception signal with a low loss. The reception signal outputted from the tunable filter 3 passes through a delay device 11, a reception coupler 81 in the canceller 8, and the low noise amplifier (LNA) 61 and is inputted to a reception RF circuit included in the RFIC 6.

A typical duplexer suppresses a transmission signal on the reception side by about 50 dB. Thus, even in the case where the antenna 1 receives out-of-band blocking at a level described in non-patent document 1, a target reception signal is hardly deteriorated.

A tunable duplexer module 7, which replaces the typical duplexer, includes the tunable filter 3, the canceller 8, the delay device 10, the delay device 11, and a control unit 5.

Before the mobile communication terminal starts transmission or reception, calibration is performed to obtain a predetermined cancelling amount in the module for the mobile communication terminal. At this point, even in the case where the cancelling amount of the leakage components of the transmission signal into a reception circuit reaches, for example, at least 20 dB, because of device manufacturing variations and temperature variations the cancelling amount of the leakage components of thermal noise generated in a reception band by a transmission circuit may become 20 dB or less.

Hence, in the case where the tunable filter 3 has a suppression amount of, for example, 30 dB for the tunable duplexer, which is insufficient for an isolation of 50 dB between transmission and reception of a typical duplexer, the control unit 5 adjusts an amplitude, a phase, and a delay such that the canceller 8 cancels the leakage components of the transmission signal and the leakage components of thermal noise by 20 dB. In the case of an adjustment for, for example, the cancellation of the transmission signal, a signal that has the same amplitude as the transmission signal in opposite phase from the transmission signal is generated using a signal outputted from the PA 62 and drawn from the transmission coupler 87. Thus, the canceller 8 includes the transmission coupler 87 that draws the output signal of the PA 62, an Rx filter 86 that attenuates the transmission signal to a predetermined level, a wide-band amplifier 84, a matching circuit 85, a matching circuit 83, a Tx filter 82 that attenuates thermal noise in the reception band to the predetermined level, and the reception coupler 81 connected to the output of the tunable filter 3.

The control unit 5 is provided in the tunable duplexer module 7 to exchange information required for control with the RFIC 6. The control unit 5 may be provided in the RFIC 6.

The configurations of the delay devices 10 and 11 provided on the signal path of the tunable filter 3 are determined by a time difference between the signal path of the tunable filter 3 and the signal path of the canceller 8. The time difference is mainly caused by the group delay of the wide-band amplifier and thus is preferably generated by, for example, a wiring pattern.

Since the wiring pattern is likely to cause a loss, the delay device 10 is disposed in the transmission system and the delay device 11 is disposed in the reception system. The delay devices may be disposed in only one of the transmission system and the reception system.

Blocks constituting the canceller 8 will be specifically described below.

The transmission coupler 87 is loosely coupled to the transmission system, so that the transmission signal and thermal noise in the reception band, which have been attenuated by about 10 dB, are drawn into the canceller 8. The reception coupler 81 is loosely coupled to the reception system, so that the transmission signal and thermal noise in the reception band are adjusted in amplitude, phase and delay, and are attenuated by about 10 dB and then are mixed with the reception RF signal outputted from the tunable filter 3. The transmission signal is attenuated by about 30 dB in the Rx filter 86. The thermal noise in the reception band is attenuated by about 30 dB in the Tx filter 82. The wide-band amplifier 84 compensates for a signal attenuation caused by the passage of the signal through the transmission coupler 87 and the reception coupler 81. The matching circuit 85 and the matching circuit 83 adjust an amplitude, a phase, and a delay.

In the case where the Rx filter 86 included in the canceller 8, the Rx filter 31 included in the tunable filter 3, the Tx filter 83 included in the canceller 8, and the Tx filter 32 included in the tunable filter 3 have substantially identical frequency characteristics, the reception coupler 81 can have a wider frequency band for cancelling the leakage components of the transmission signal and the leakage components of thermal noise.

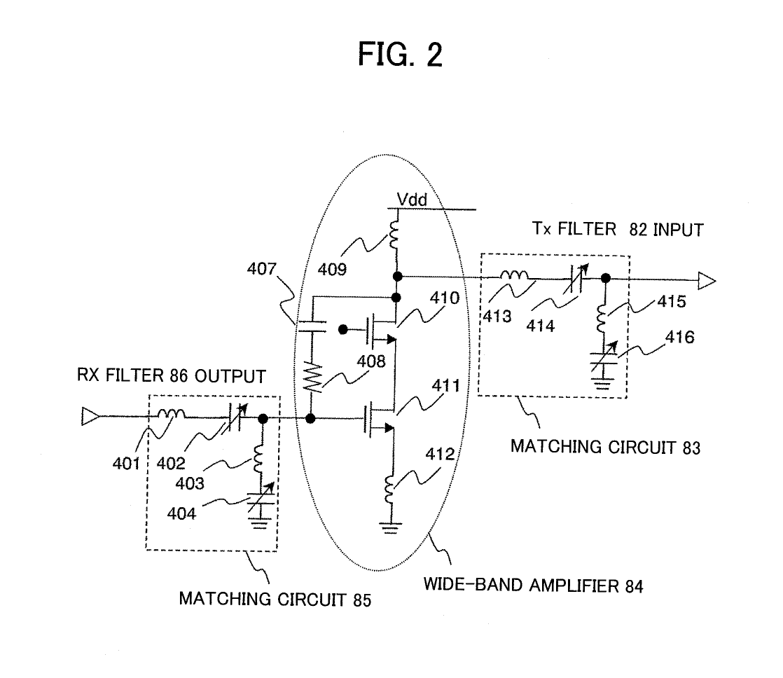

FIG. 2 is a circuit diagram of the matching circuit 85, the wide-band amplifier 84, and the matching circuit 83.

The matching circuit 85 includes an inductor 401, a variable capacitor 402, an inductor 403, and a variable capacitor 404. The matching circuit 83 includes an inductor 413, a variable capacitor 414, an inductor 415, and a variable capacitor 416.

The variable capacitor is disposed to adjust an amplitude, a phase, and a delay and preferably includes a varicap that varies a capacitance value according to an externally applied voltage and a capacitor bank that is switched by a MOS switch. A voltage applied to the varicap and a switching signal sent to the MOS switch to switch the capacitor bank are supplied from the control unit 5 of FIG. 1.

The layout of the inductors and the variable capacitors in FIG. 2 is a structural example of the matching circuit. The configuration of the device layout is not limited to this example.

The wide-band amplifier 84 includes an NMOS transistor 410, an NMOS transistor 411, an inductor 409, an inductor 412, a capacitor 407, and a resistor 408. A bias circuit is omitted. The capacitor 407 and the resistor 408 constitute a feedback circuit, so that wide-band characteristics are obtained.

The layout of the wide-band amplifier 84 in FIG. 2 is a structural example of a wide-band amplifier circuit. The configuration of the device layout is not limited to this example.

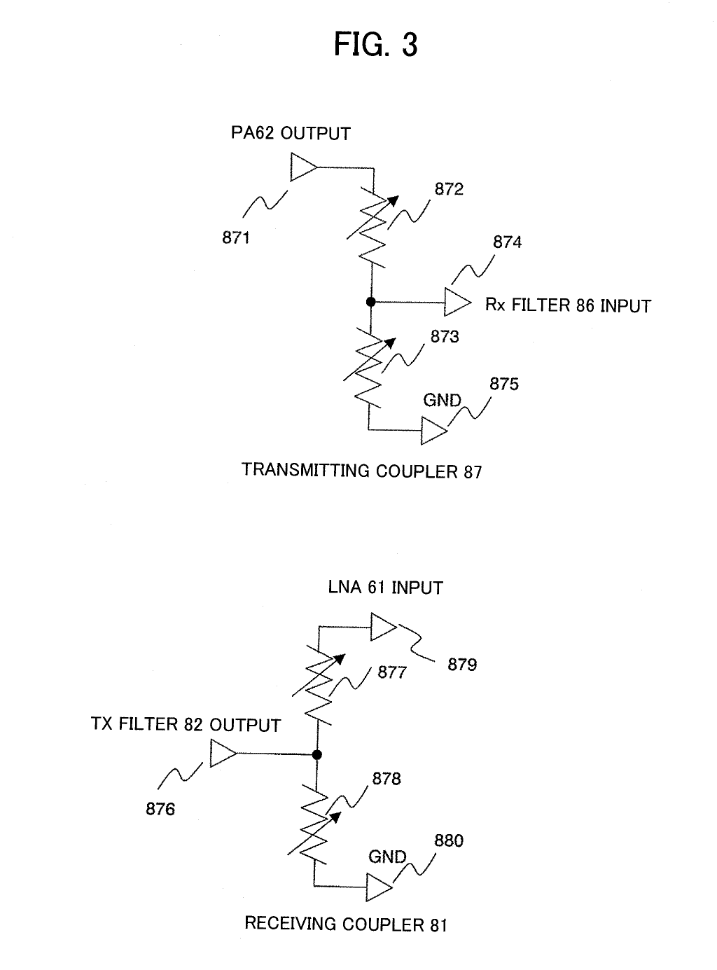

FIG. 3 is a circuit diagram illustrating the transmission coupler 87 and the reception coupler 81. The transmission coupler 87 includes a terminal 871 connected to the output of the PA 62, a variable resistor 872, a variable resistor 873, a terminal 874 connected to the input of the Rx filter 86 in the canceller 8, and a terminal 875 connected to the ground. The reception coupler 81 includes a terminal 876 connected to the output of the Tx filter 82 in the canceller 8, a variable resistor 877, a variable resistor 878, a terminal 879 connected to the input of the LNA 61, and a terminal 880 connected to the ground.

Impedance matching needs to be performed each time the tunable filter 3 switches frequency bands or channels in the same band. Thus, the control unit 5 sets the variable resistors 872, 873, 877, and 878 at an optimal value. The variable resistor preferably switches resistor banks by a MOS switch. A switching signal for switching the resistor banks is supplied to the MOS switch from the control unit 5 illustrated in FIG. 1.

The resistance values of the variable resistor 872 and the variable resistor 873 are preferably so large relative to the input impedance of the Tx filter 32 in the tunable filter 3 that the transmission coupler 87 is loosely coupled to the transmission system (for example, coupling of 10 dB). The resistance values of the variable resistor 877 and the variable resistor 878 are preferably so large relative to the output impedance of the Rx filter 31 in the tunable filter 3 that the reception coupler 81 is loosely coupled to the reception system (for example, coupling of 10 dB).

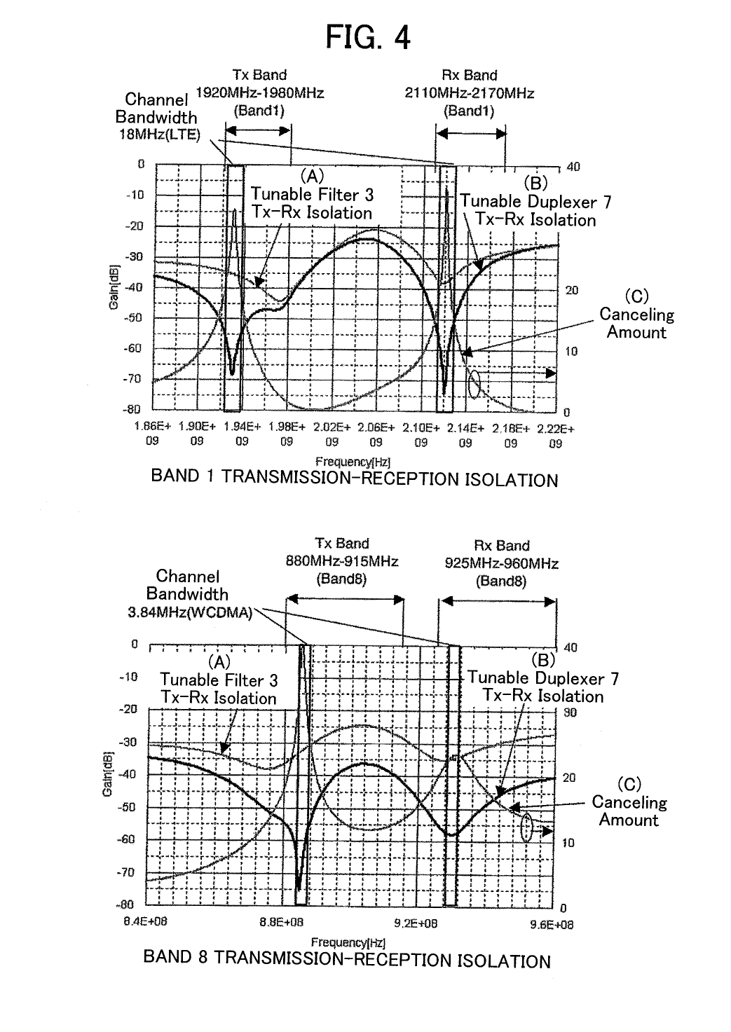

FIG. 4 illustrates isolation characteristics between transmission and reception of the tunable duplexer module 7. Band 1 has a transmission band ranging from 1920 MHz to 1980 MHz and a reception band ranging from 2110 MHz to 2170 MHz (see the upper chart). In order to sufficiently suppress the leakage components of the transmission signal on the reception side, the transmission band requires an isolation of at least 50 dB. Moreover, in order to sufficiently suppress the leakage components of thermal noise in the reception band in the transmission signal, the reception band requires an isolation of at least 50 dB.

The tunable filter 3 alone has an isolation of about 30 dB (A in FIG. 4) in the transmission band and the reception band (see the left vertical axis in FIG. 4). The isolation is not enough relative to the 50-dB isolation of a typical duplexer. For example, in LTE, defined channel bandwidths are 1.4 MHz, 3 MHz, 5 MHz, 10 MHz, 15 MHz, and 20 MHz (see non-patent document 1). The maximum occupied bandwidth of a channel corresponds to 18 MHz in the transmission band and the reception band (a maximum channel bandwidth of 20 MHz). Thus, an isolation of at least 50 dB needs to be obtained within this range (an integral of the occupied bandwidth). In the present embodiment, about 20 dB (see the right vertical axis in FIG. 4) is added as a cancelling amount (C in FIG. 4) of the canceller 8. Thus, in an occupied bandwidth surrounded by a thick line in FIG. 4, the transmission band and the reception band each have an isolation of at least 50 dB (B in FIG. 4) in the overall tunable duplexer module 7 (see the left vertical axis in FIG. 4).

Band 8 has a transmission band ranging from 880 MHz to 915 MHz and a reception band ranging from 925 MHz to 960 MHz (see the lower chart). Unlike in the upper chart, an occupied bandwidth of 3.84 Hz (a channel bandwidth of 5 MHz; cf. 3GPP TS36.101 V8.8.0(2009-10)) in WCDMA is surrounded by a thick line. About 20 dB is added as a cancelling amount of the canceller 8, so that the transmission band and the reception band each have an isolation of at least 50 dB in a single occupied bandwidth.

As described above, multiple frequency bands and multiple channels in the same band are provided in the WCDMA and LTE systems. The tunable duplexer module 7 provides optimal frequency characteristics for the multiple frequency bands and the multiple channels in the same band in a tunable manner.

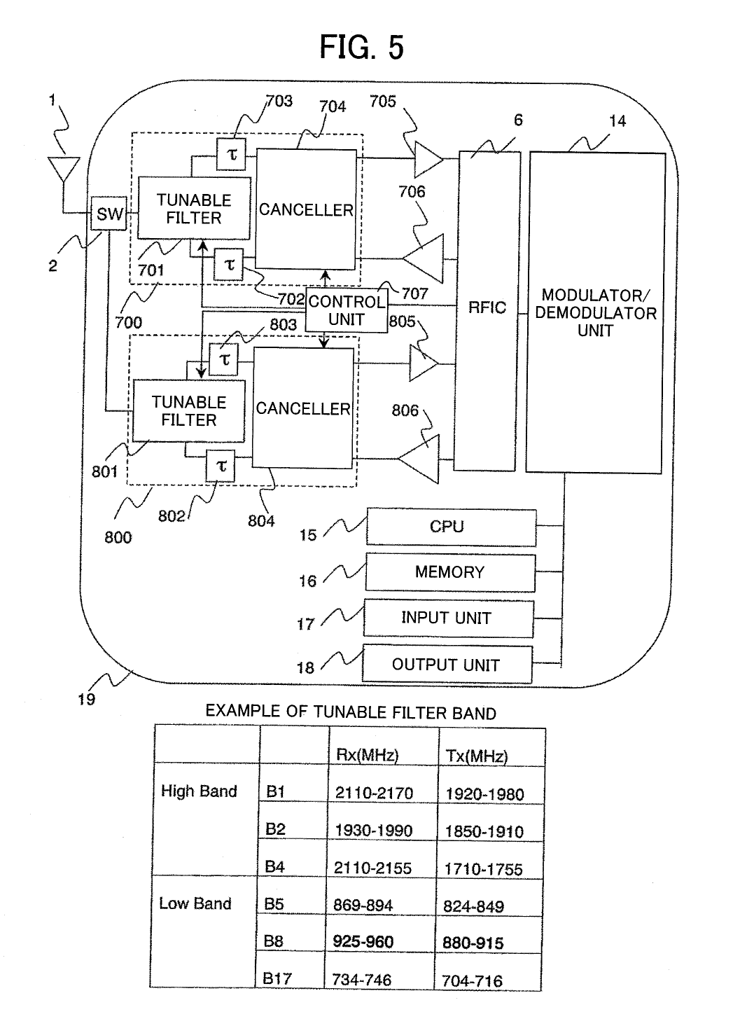

FIG. 5 is a block diagram illustrating an application of the present embodiment to a mobile communication terminal. In the case where Bands 1, 2, 4, 5, 8, and 17 are received as an example of multiple bands, Bands 5, 8, and 17 ranging from 700 M to 800 MHz serve as Low Bands and Bands 1, 2, and 4 ranging from 1700 M to 2100 MHz serve as High Bands in the configuration of the terminal.

A mobile communication terminal 19 includes the antenna 1, the antenna SW2, a tunable duplexer module 700, a tunable duplexer module 800, the RFIC 6, an LNA 705, a PA 706, an LNA 805, a PA 806, a control unit 707, a modulator/demodulator unit 14, a CPU 15, a memory 16, an input unit 17, and an output unit 18.

For example, the antenna 1 is preferably shared by switching the tunable duplexer module 700 for High Band and the tunable duplexer module 800 for Low Band by means of the antenna SW2.

The tunable duplexer module 700 includes a tunable filter 701, a canceller 704, a delay device 702, and a delay device 703. The tunable duplexer module 800 includes a tunable filter 801, a canceller 804, a delay device 802, and a delay device 803. The tunable duplexer modules 700 and 800 are controlled by the control unit 707.

Information data and an audio signal that are inputted from the input unit 17 are modulated in a format conforming to, for example, radio communication standards by the modulator/demodulator unit 14, are supplied to the RFIC 6, and then are transmitted from the antenna 1 through the constituent elements including the tunable duplexer modules 700 and 800.

A signal received by the antenna 1 is supplied to the modulator/demodulator unit 14 through the constituent elements including the tunable duplexer modules 700 and 800 and is demodulated to obtain modulation at the time of transmission. Information data and an audio signal that are obtained by the demodulation are outputted from the output unit 18 and then are supplied to a user or an external device (not shown).

The CPU 15 controls the overall operations of the mobile communication terminal 19 including the modulator/demodulator unit 14. Software and firmware for operating the CPU 15 are stored in the memory 16.

As described above, a feature of the present embodiment is that the canceller is used to compensate for a shortage of isolation between transmission and reception by means of the tunable duplexer. The delay devices 10 and 11 corresponding to a time difference from the signal path of the canceller 8 are disposed on the signal path of the tunable filter 3. The canceller includes the matching circuit that adjusts an amplitude, a phase, and a delay, the wide-band amplifier that has small amplitude fluctuations and small phase fluctuations over the frequency bands of the transmission signal and the reception signal, the variable impedance transmission coupler, and the variable impedance reception coupler. Thus, the provided canceller can have a predetermined cancelling amount over a wide band, improving the basic performance of the mobile communication terminal.

Another feature is that the tunable duplexer can eliminate an increase in the size of a reception circuit in, for example, WCDMA and LTE mobile communication terminals.

### Second Embodiment

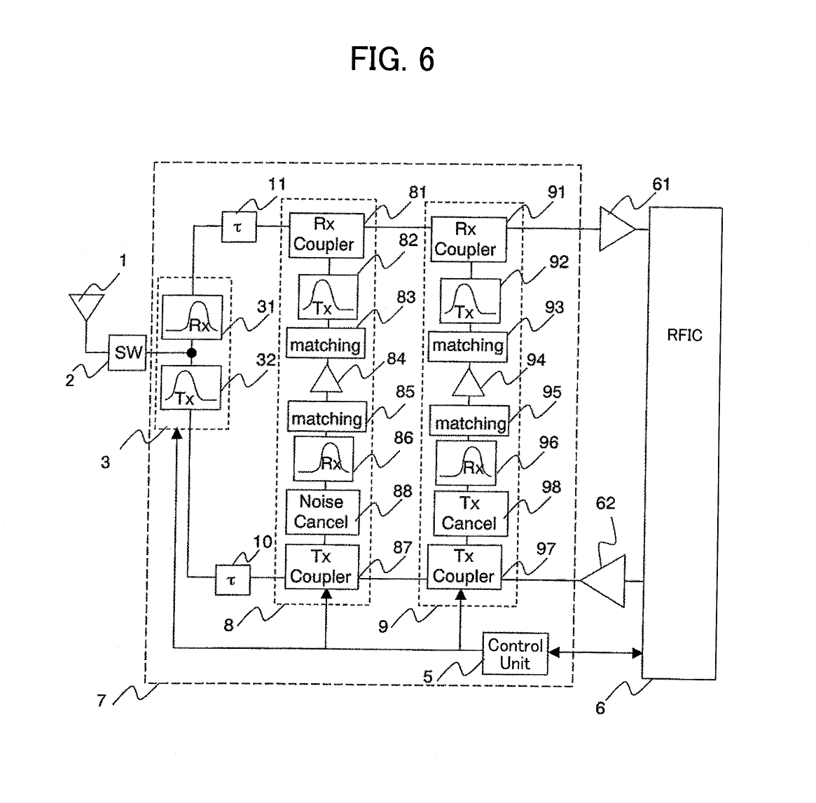

FIG. 6 is a block diagram illustrating a structural example of a module for a mobile communication terminal according to a second embodiment. The flows of a transmission signal and a reception signal are identical to those of the first embodiment and thus the explanation thereof is omitted. In this configuration, a signal for cancelling the leakage components of a transmission signal from the output of a PA 62 is generated by a canceller 8 and a signal for cancelling the leakage components of thermal noise in a reception band is generated by a canceller 9. The canceller 8 includes a noise canceller 88 that removes thermal noise in the reception band in ₜhe transmission signal. The canceller 9 includes a Tx canceller 98 that removes the transmission signal.

Blocks constituting the cancellers 8 and 9 will be specifically described below.

A transmission coupler 87 is loosely coupled to a transmission system, so that the transmission signal and thermal noise in the reception band, which have been attenuated by about 10 dB, are drawn into the canceller 8. A reception coupler 81 is loosely coupled to a reception system, so that the transmission signal adjusted in amplitude, phase, and delay is attenuated by about 10 dB and then is mixed with a reception RF signal from the output of a tunable filter 3. The transmission signal is attenuated by about 30 dB in an Rx filter 86. The thermal noise in the reception band is attenuated by about 30 dB in a Tx filter 82. A wide-band amplifier 84 compensates for a signal attenuation caused by the passage of the signal through the transmission coupler 87 and the reception coupler 81. A matching circuit 85 and a matching circuit 83 adjust an amplitude, a phase, and a delay.

The noise canceller 88 preferably includes a phase shifter and a mixer. Thermal noise in the reception band at the output of the PA 62 is inverted by 180° by the phase shifter and then is canceled by the mixer. A transmission signal not inverted in phase passes through the noise canceller 88.

A reception coupler 97 is loosely coupled to the transmission system, so that the transmission signal and thermal noise in the reception band, which have been attenuated by about 10 dB, are drawn into the canceller 9. A reception coupler 91 is loosely coupled to the reception system, so that thermal noise in the reception band adjusted in amplitude, phase, and delay is attenuated by about 10 dB and then is mixed with the reception RF signal from the output of the tunable filter 3. The transmission signal is attenuated by about 30 dB in an Rx filter 96. The thermal noise in the reception band is attenuated by about 30 dB in a Tx filter 92. A wide-band amplifier 94 compensates for a signal attenuation caused by the passage of the signal through the transmission coupler 97 and the reception coupler 91. A matching circuit 95 and a matching circuit 93 adjust an amplitude, a phase, and a delay.

The Tx canceller 98 preferably includes a phase shifter and a mixer. The transmission signal from the output of the PA 62 is inverted by 180° by the phase shifter and then is cancelled by the mixer. Thermal noise in the reception band not inverted in phase passes through the Tx canceller 98.

In the present embodiment, the signal for cancelling the transmission signal from the output of the PA 62 is generated by the canceller 8 and the signal for cancelling thermal noise in the reception band is generated by the canceller 9, so that each of the cancellers only needs to cover a small band. Hence, the accuracy of a cancelling amount can be improved.

### Third Embodiment

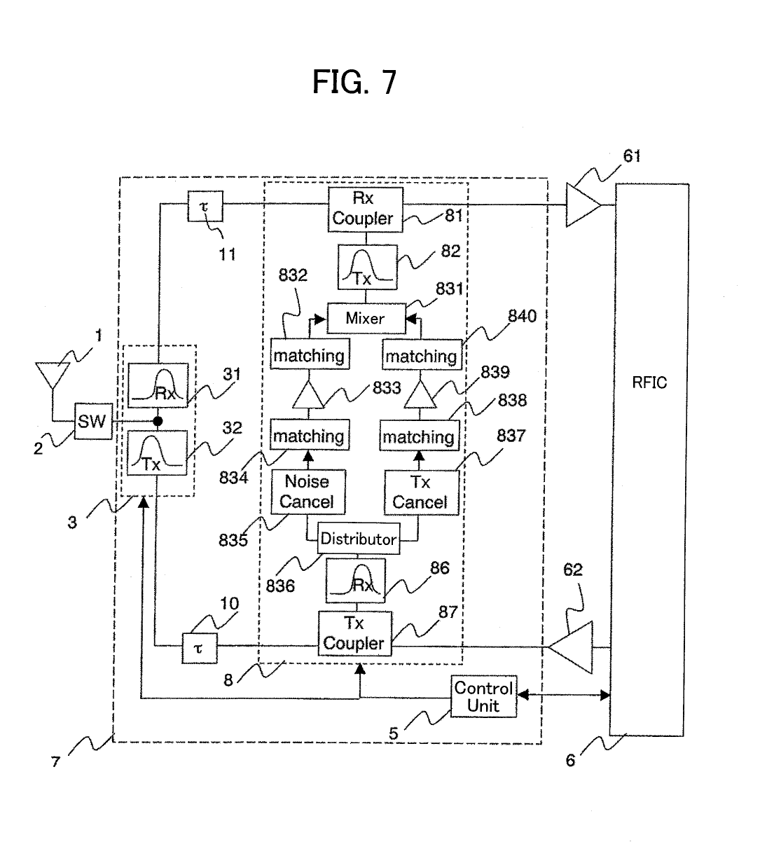

FIG. 7 is a block diagram illustrating a structural example of a module for a mobile communication terminal according to a third embodiment. The flows of a transmission signal and a reception signal are identical to those of the first embodiment and thus the explanation thereof is omitted. In this configuration, a signal for cancelling the leakage components of a transmission signal from the output of a PA 62 and the leakage components of thermal noise in a reception band is generated by a canceller 8. In the canceller 8, a signal path is split such that a signal for cancelling the transmission signal is generated in one of the split paths and a signal for cancelling thermal noise in the reception band is generated in the other path. A system for generating the signal for cancelling the transmission signal includes a noise canceller 835 that removes thermal noise in the reception band. A system for generating the signal for cancelling thermal noise in the reception band includes a Tx canceller 837 that removes the transmission signal.

Blocks constituting the canceller 8 will be specifically described below.

A transmission coupler 87 is loosely coupled to a transmission system, so that the transmission signal and thermal noise in the reception band, which have been attenuated by about 10 dB, are drawn into the canceller 8. A reception coupler 81 is loosely coupled to a reception system, so that the transmission signal and thermal noise in the reception band are adjusted in amplitude, phase and delay, and are attenuated by about 10 dB and then are mixed with a reception RF signal from the output of a tunable filter 3. The transmission signal is attenuated by about 30 dB in an Rx filter 86. The thermal noise in the reception band is attenuated by about 30 dB in a Tx filter 82. A distributor 836 is connected to the output of the Rx filter 86. The distributor 836 splits to the noise canceller 835 and the Tx Canceller 837. A mixer 831 is connected to the input of the Tx filter 82 to mix thermal noise and a signal that is processed after being split at the distributor 836. A wide-band amplifier 833 compensates for a signal attenuation caused by the passage of the signal through the transmission coupler 87, the reception coupler 81, the distributor 836, and the mixer 831. A matching circuit 834 and a matching circuit 832 adjust an amplitude, a phase, and a delay. A wide-band amplifier 839 compensates for a signal attenuation caused by the passage of the signal through the transmission coupler 87, the reception coupler 81, the distributor 836, and the mixer 831. A matching circuit 838 and a matching circuit 840 adjust an amplitude, a phase, and a delay.

The noise canceller 835 preferably includes a phase shifter and a mixer. Thermal noise in the reception band at the output of the distributor 836 is inverted by 180° by the phase shifter and then is canceled by the mixer. A transmission signal not inverted in phase passes through the noise canceller 835.

The Tx canceller 837 preferably includes a phase shifter and a mixer. The transmission signal from the output of the distributor 836 is inverted by 180° by the phase shifter and is cancelled by the mixer. Thermal noise in a reception band not inverted in phase passes through the Tx canceller 837.

In the present embodiment, the transmission signal from the output of the PA 62 and thermal noise in the reception band are separately processed in the canceller 8, so that each of the wide-band amplifiers only needs to cover a small band. Hence, the accuracy of a cancelling amount can be improved. Moreover, the provision of the single transmission coupler and the single reception coupler can reduce a passage loss in the transmission system and the reception system. Unlike in FIG. 6, the single Rx filter 86 and the single Tx filter 82 are provided in the canceller.

The above embodiments are merely exemplary and the present invention is not limited to these embodiments. The block diagrams and the circuit diagrams may be modified within the scope of the present invention.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A module for a mobile communication terminal in which a transmission RF signal and a reception RF signal have different frequency bands,
the module comprising:
a duplexer filter including:
a Tx filter that receives the transmission RF signal from an external transmission RF circuit , allows passage of a signal in a frequency band of the transmission RF signal, and supplies the signal to an external antenna, and
an Rx filter that receives the reception RF signal from the antenna, allows passage of a signal in a frequency band of the reception RF signal, and supplies the signal to an external reception RF circuit;
a canceller unit that splits a part of the transmission RF signal from a front stage of the Tx filter included in the duplexer filter, performs predetermined signal processing on the signal, couples the signal with the reception RF signal in a rear stage of the Rx filter included in the duplexer filter, and cancels leakage components of the transmission RF signal in the reception RF signal and leakage components of thermal noise, to the reception RF signal, in the frequency band of the reception RF signal in the transmission RF signal; and
a signal delay unit that compensates for a time difference between the signal passing through the duplexer filter and the signal passing through the canceller unit.

2. The module for a mobile communication terminal according to claim 1, wherein the signal delay unit is provided between the canceller unit that partially splits the transmission RF signal and the Tx filter and/or between the Rx filter allowing passage of the reception RF signal and the canceller unit that couples the reception RF signal with the transmission RF signal having been subjected to the predetermined signal processing.

3. The module for a mobile communication terminal according to claim 1, wherein the canceller unit includes:
a second Tx filter that has substantially identical frequency characteristics to the Tx filter included in the duplexer filter; and
a second Rx filter that has substantially identical frequency characteristics to the Rx filter included in the duplexer filter.

4. The module for a mobile communication terminal according to claim 1, wherein the canceller unit includes a coupler that couples, with a variable impedance, the transmission RF signal having been subjected to the predetermined signal processing to the reception RF signal.

5. The module for a mobile communication terminal according to claim 1, wherein the duplexer filter is a tunable filter that has a variable frequency band allowing passage of the transmission RF signal and the reception RF signal.

6. The module for a mobile communication terminal according to claim 1, wherein optimal frequency characteristics are provided in a tunable manner not only for a plurality of frequency bands but also for a plurality of channels in the same band.

7. A module for a mobile communication terminal in which a transmission RF signal and a reception RF signal have different frequency bands,
the module comprising:
a duplexer filter including:
a Tx filter that receives the transmission RF signal from an external transmission RF circuit , allows passage of a signal in a frequency band of the transmission RF signal, and supplies the signal to an external antenna, and
an Rx filter that receives the reception RF signal from the antenna, allows passage of a signal in a frequency band of the reception RF signal, and supplies the signal to an external reception RF circuit;
a first canceller unit that splits a part of the transmission RF signal from a front stage of the Tx filter included in the duplexer filter, performs predetermined signal processing on the signal, couples the signal with the reception RF signal in a rear stage of the Rx filter included in the duplexer filter, and cancels leakage components of the transmission RF signal in the reception RF signal; and
a second canceller unit that splits a part of the transmission RF signal from the front stage of the Tx filter included in the duplexer filter, performs the predetermined signal processing on the signal, couples the signal with the reception RF signal in the rear stage of the Rx filter included in the duplexer filter, and cancels leakage components of thermal noise, to the reception RF signal, in the frequency band of the reception RF signal in the transmission RF signal.

8. A module for a mobile communication terminal in which a transmission RF signal and a reception RF signal have different frequency bands,
the module comprising:
a duplexer filter including:
a Tx filter that receives the transmission RF signal from an external transmission RF circuit, allows passage of a signal in a frequency band of the transmission RF signal, and supplies the signal to an external antenna, and
an Rx filter that receives the reception RF signal from the antenna, allows passage of a signal in a frequency band of the reception RF signal, and supplies the signal to an external reception RF circuit;
a canceller unit that splits a part of the transmission RF signal from a front stage of the Tx filter included in the duplexer filter, performs predetermined signal processing on the signal, couples the signal with the reception RF signal in a rear stage of the Rx filter included in the duplexer filter, and cancels leakage components of the transmission RF signal in the reception RF signal and leakage components of thermal noise, to the reception RF signal, in the frequency band of the reception RF signal in the transmission RF signal; and
a signal delay unit that compensates for a time difference between the signal passing through the duplexer filter and the signal passing through the canceller unit;
wherein the canceller unit includes a distributor, a mixer, a first cancelling circuit, a second cancelling circuit, and a coupler,
the distributor distributes the transmission RF signal split from the front stage of the Tx filter included in the duplexer filter and supplies the signal to the first cancelling circuit and the second cancelling circuit,
the first cancelling circuit performs the predetermined signal processing on the transmission RF signal to invert a phase of the transmission RF signal and supplies the signal to the mixer,
the second cancelling circuit performs the predetermined signal processing on the transmission RF signal to invert a phase of thermal noise in the frequency band of the reception RF signal in the transmission signal and supplies the signal to the mixer,
the mixer mixes an output from the first cancelling circuit and an output supplied from the second cancelling circuit and supplies the mixed output to the coupler, and
the coupler couples the reception RF signal and an output from the mixer.

9. A mobile communication terminal comprising a communication antenna that transmits a transmission RF signal containing an information signal and receives a reception RF signal, the transmission RF signal and the reception RF signal having different frequency bands,
the mobile communication terminal further comprising:
a modulator/demodulator unit that generates the transmission RF signal with the inputted information signal serving as a modulation signal in a format conforming to a wireless communication standard, demodulates the reception RF signal received by the antenna, and outputs the information signal; and
a mobile terminal module that supplies, to the antenna, the transmission RF signal supplied from the modulator/demodulator unit, and supplies, to the modulator/demodulator unit, the reception RF signal supplied from the antenna,
the mobile terminal module including:
a duplexer filter including: a Tx filter that allows passage of a signal in a frequency band of the transmission RF signal and supplies the signal to the antenna, and
an Rx filter that allows passage of a signal in a frequency band of the reception RF signal and supplies the signal to the modulator/demodulator unit;
a canceller unit that splits a part of the transmission RF signal from a front stage of the Tx filter included in the duplexer filter, performs predetermined signal processing on the signal, couples the signal with the reception RF signal in a rear stage of the Rx filter included in the duplexer filter, and cancels leakage components of the transmission RF signal in the reception RF signal and leakage components of thermal noise, to the reception RF signal, in the frequency band of the RF signal in the transmission RF signal; and
a signal delay unit that compensates for a time difference between the signal passing through the duplexer filter and the signal passing through the canceller unit.

10. The mobile communication terminal according to claim 9, wherein the canceller unit includes a coupler that couples, with a variable impedance, the transmission RF signal having been subjected to the predetermined signal processing to the reception RF signal.
